(19) United States
(12) Patent Application Publication
(10) Pub. No.: US 2015/0098368 A1
(43) Pub. Date: Apr. 9, 2015

(54) METHOD AND APPARATUS FOR INVOKING A RESPONSE OF THE CURRENT TDD SUBFRAME CONFIGURATION

(71) Applicants: Teck Hu, Melbourne, FL (US); Jiyong Pang, Shanghai (CN)

(72) Inventors: Teck Hu, Melbourne, FL (US); Jiyong Pang, Shanghai (CN)

(73) Assignee: Alcatel Lucent, Boulogne Billancourt (FR)

(21) Appl. No.: 14/400,221

(22) PCT Filed: May 11, 2012
(86) PCT No.: PCT/CN2012/075344

§ 371 Date: Nov. 10, 2014

(51) Int. Cl. H04L 5/00; H04L 5/14

(52) U.S. Cl. CPC H04L 5/0053; H04L 5/14
USPC 370/280

(57) ABSTRACT

The invention provides a method and apparatus for invoking a response of a current TDD subframe configuration. First, the first base station sends to the second base station a first message for invoking a response of a current TDD subframe configuration of the second base station. Second, the second base station receives the first message from the first base station and then sends to the first base station a second message in response to the first message, the second message including the current TDD subframe configuration of the second base station. Third, the first base station receives the second message from the second base station and acquires the current TDD subframe configuration of the second base station from the second message. The first message can be a LOAD INFORMATION message, wherein the LOAD INFORMATION message comprises a TDD subframe assignment invoke included in an Invoke Indication IE, and the TDD subframe assignment invoke is used for indicating the invoke of the response of the current TDD subframe configuration of the second base station.

### FIELD OF THE INVENTION

The application relates to communication systems, and particularly to wireless communications.

### BACKGROUND OF THE INVENTION

In LTE-Advanced, the use of dynamic reconfiguration of TDD (time division duplexing) frame allocation is currently being considered for possible standardization in Release 11. This feature is motivated by TDD spectrum operator desire to better control interference from co-channel deployments and for traffic adaptation.

In patent applications No. PCT/CN2012.070734 and PCT/CN2012/070739 both filed on Jan. 29, 2012, the inventors have proposed methods to adapt the Release 10 Overload Indicator (OI) and High Interference Indicator (HII) to report/inform interference respectively. To be specific, referring to FIG. 1, for BS-to-BS interference, BS1 (i.e. the interfering BS) sends a DL subframe while BS2 (i.e. the interfered BS) would be receiving a UL subframe1; thus BS1 may causes interference to BS2. Using the adapted OI, BS2 can report its suffered interference to BS1. By receiving the adapted OI, BS 1 may then modify its downlink transmission behavior to mitigate or avoid the interference. For UE-to-UE interference, UE2 sends a UL subframe while UE1 would be receiving a DL subframe; thus UE2 may cause interference to UE1. Using the adapted HIL BS2 can inform of high UL interference to BS 1. By receiving the adapted HII, BS1 may limit its DL scheduling to UE1, thus preventing a severe degradation of the DL transmission at UE1. Please refer to those two patent applications mentioned above for details.

However, the methods proposed in patent applications above are predicated on the condition that BS1 knows the current subframe configurations both in BS1 and BS2. As a matter of fact, after receiving the adapted OI or HII, BS1 requires to know the mismatch of TDD assignment between BS 1 and BS2, namely BS 1 requires to know the information of current TDD subframe configuration of BS2, such that BS1 could achieve the purpose of mitigating or avoiding interference more accurately.

In addition, there could still be scenarios where information of current (latest) TDD subframe configurations of the neighboring BSs are not up-to-date:

(1) Dynamic reconfiguration of the TDD subframe at one BS before the Served Cell Information IE Group can be sent to the neighboring BSs;

(2) Not all the neighboring BSs are sent the Served Cell Information IE Group in order to reduce and optimize the X2 signaling load;

(3) Not all the neighboring BSs need to be sent the Served Cell Information IE Group as they could be perceived as low risk BSs from the point of view of the BS that is changing its TDD subframe assignment;

(4) A BS intending to reconfigure its TDD subframe may request uptodate information of the neigboring cell subframe assignement to aid its decision to whether or not to reconfigure its TDD subframe.

Therefore, there is a need of proposing an approach for a BS to request from its neighboring BS the current TDD subframe of the neighboring BS.

### OBJECT AND SUMMARY OF THE INVENTION

In one aspect of the invention, there is provided a method, in a first base station of a communication system, of invoking a response of a current TDD subframe configuration from a second base station, the method comprising the step of: sending to the second base station a first message for invoking the response of the current TDD subframe configuration of the second base station.

Advantageously, the method may further comprise the method of: receiving from the second base station a second message in response to the first message, the second message including the current TDD subframe configuration of the second base station.

Advantageously, the first message may be a LOAD INFORMATION message, wherein the LOAD INFORMATION message comprises a TDD subframe assignment invoke included in an invoke indication IE, and the TDD subframe assignment invoke is used for indicating the invoke of the response of the current TDD subframe configuration of the second base station.

In another aspect of the invention, there is provided a method, in a second base station of a communication system, of providing a current TDD subframe configuration to a first base station, the method comprising the step of: receiving from the first base station a first message for invoking the response of a current TDD subframe configuration of the second base station.

Advantageously, the method may further comprise the method of: sending to the first base station a second message in response to the first message, the second message including the current TDD subframe configuration of the second base station.

Advantageously, the first message may be a LOAD INFORMATION message, wherein the LOAD INFORMATION message comprises a TDD subframe assignment invoke included in an invoke indication IE, and the TDD subframe assignment invoke is used for indicating the invoke of the response of the current TDD subframe configuration of the second base station.

Advantageously, the second message may be an ENB CONFIGURATION UPDATE message.

In another aspect of the invention, there is provided an apparatus, in a first base station of a communication system, for invoking a response of a current TDD subframe configuration from a second base station, the apparatus comprising: a first sending unit for sending to the second base station a first message for invoking a response of the current TDD subframe configuration of the second base station.

In another aspect of the invention, there is provided an apparatus, in a second base station of a communication system, of providing a current TDD subframe configuration to a first base station, the apparatus comprising: a second receiving unit for receiving from the first base station a first message for invoking a response of a current TDD subframe configuration of the second base station.

### BRIEF DESCRIPTION OF THE DRAWINGS

The invention is explained in further detail, and by way of example, with reference to the accompanying drawings wherein:

FIG. 1 shows a schematic view of BS-BS and UE-UE interference scenarios;

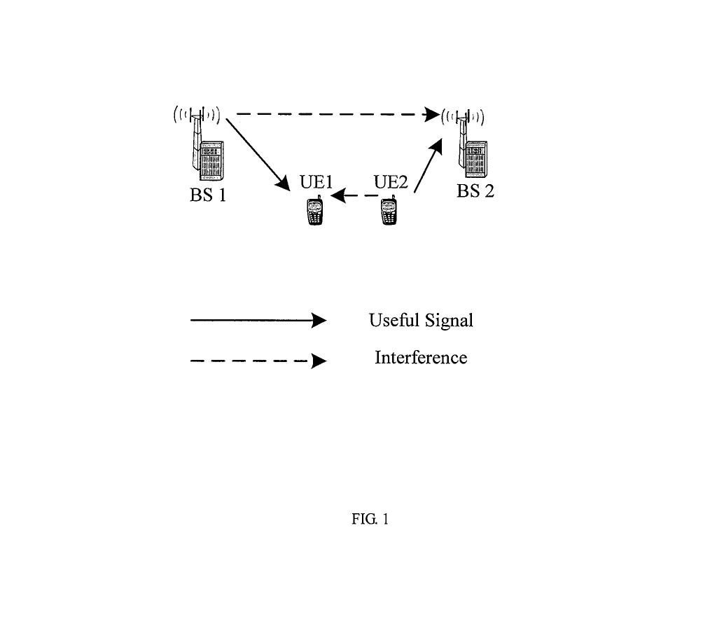

FIG. 2 shows a flow chart of a method of invoking a response of the current TDD subframe configuration.

Throughout the above drawings, like reference numerals will be understood to refer to like, similar or corresponding features or functions.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Hereinafter, the technical solutions of foregoing aspects of the invention will be described in great detail.

For illustrative purpose only, in the embodiments of the invention, it is assumed that the wireless communication system comprises two base stations, i.e. BS 10 and BS 20, and BS 10 would like to know the current TDD subframe configuration of BS 20 for some purposes, for example, to mitigate or avoid its interference to BS 20.

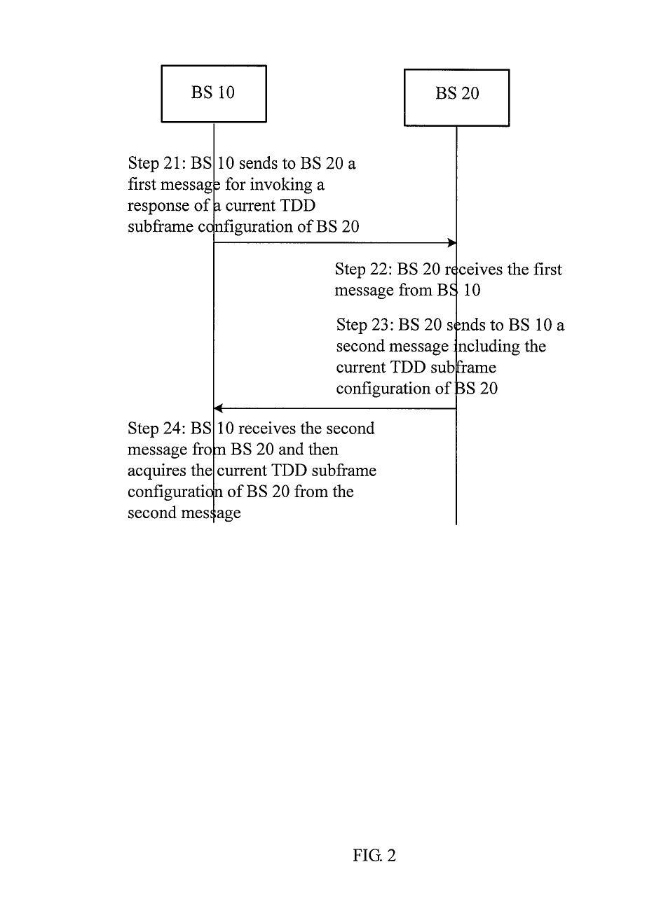

Referring to FIG. 2, first, in Step 21, BS 10 sends to BS 20 a first message for invoking a response of the current TDD subframe configuration of BS 20.

In one example, the first message can be the existing LOAD INFORMATION message in which the use of Invoke Indication IE is expanded so as to achieve the purpose of invoking the response of the current TDD subframe configuration. To be specific, a new function of invoking the response of the TDD subframe configuration is included in the Invoke Indication IE. The expanded Invoke Indication IE is defined as follows in Table 1.

| | | | IE type and | Semantics |
|---|---|---|---|---|
| IE/Group Name | Presence | Range | reference | description |
| Invoke Indication | M | | ENUMERATED | — |
| | | | (ABS | |
| | | | Information, | |
| | | | TDD Subframe | |
| | | | Assignment, . . . ) | |

As can be seen in Table 1, a new function of invoking the response of ‘TDD subframe assigment’ (the words in italic) is added in the field of IE type and reference. As Invoke Indication IE provides an indication about which type of information the sending eNB would like the receiving eNB to send back, when a TDD subframe assignment invoke is put in Invoke Indication IE and sent to BS 20, based on the TDD subframe assignment invoke in the received Invoke Indication IE, BS 20 would know that BS 10 invokes it to send back its current TDD subframe configuration.

In another example, the first message can be a new message which is dedicated for invoking a response of the current TDD subframe configuration. In this regard, a new TDD subframe assignment Invoke IE can be defined.

After BS 10 sends the first message to BS 20, in Step 22, BS 20 would receive the first message from BS 10. Using the LOAD INFORMATION message as an example of the first message, when receiving the LOAD INFORMATION message, based on the TDD subframe assignment invoke included in Invoke Indication IE, BS 20 would know that BS 10 invokes it to send back its current TDD subframe configuration.

In response to the first message, in Step 23, BS 20 may send to BS 10 a second message including the current TDD subframe configuration of BS 20. The second message can be the existing ENB CONFIGURATION UPDATE message, for example. Or the second message can be a new message which is dedicated to feed back the current TDD subframe configuration.

After BS 20 sends the second message to BS 10, in Step 24, BS 10 would receive the second message from BS 20 and then acquire the current TDD subframe configuration of BS 20 from the second message.

It is to be noted that the TDD subframe assignment invoke sent to BS 20 is not necessary or mandatory for BS 20 to reply. In an alternative embodiment, when BS 20 receives the first message (i.e. the TDD subrame assignment invoke included in Indication Invoke IE), it may choose not to respond to the first message.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method, in a first base station of a communication system, of invoking a response of a current TDD subframe configuration from a second base station, the method comprising:
sending to the second base station a first message for invoking the response of the current TDD subframe configuration of the second base station.

2. The method of claim 1, further comprising the method of:
receiving from the second base station a second message in response to the first message, the second message including the current TDD subframe configuration of the second base station.

3. The method of claim 1, wherein the first message is a LOAD INFORMATION message, wherein the LOAD INFORMATION message comprises a TDD subframe assignment invoke included in an Invoke Indication IE, and the TDD subframe assignment invoke is used for indicating the invoke of the response of the current TDD subframe configuration of the second base station.

4. A method, in a second base station of a communication system, of providing a current TDD subframe configuration to a first base station, the method comprising:
receiving from the first base station a first message for invoking a response of a current TDD subframe configuration of the second base station.

5. The method of claim 4, further comprising:
sending to the first base station a second message in response to the first message, the second message including the current TDD subframe configuration of the second base station.

6. The method of claim 4, wherein the first message is a LOAD INFORMATION message, wherein the LOAD INFORMATION message comprises a TDD subframe assignment invoke included in an Invoke Indication IE, and the TDD subframe assignment invoke is used for indicating the invoke of the response of the current TDD subframe configuration of the second base station.

7. The method of claim 5, wherein the second message is an ENB CONFIGURATION UPDATE message.

8. An apparatus, in a first base station of a communication system, for invoking a response of a current TDD subframe configuration from a second base station, the apparatus comprising:
a first sending unit for sending to the second base station a first message for invoking a response of the current TDD subframe configuration of the second base station.

9. The apparatus of claim 8, further comprising:
a first receiving unit for receiving from the second base station a second message in response to the first message, the second message including the current TDD subframe configuration of the second base station.

10. The apparatus of claim 8, wherein the first message is a LOAD INFORMATION message, wherein the LOAD INFORMATION message comprises a TDD subframe assignment invoke included in an Invoke Indication IE, and the TDD subframe assignment invoke is used for indicating the invoke of the response of the current TDD subframe configuration of the second base station.

11. An apparatus, in a second base station of a communication system, of providing a current TDD subframe configuration to a first base station, the apparatus comprising:
a second receiving unit for receiving from the first base station a first message for invoking a response of a current TDD subframe configuration of the second base station.

12. The apparatus of claim 11, further comprising:
a second sending unit for sending to the first base station a second message in response to the first message, the second message including the current TDD subframe configuration of the second base station.

13. The apparatus of claim 11, wherein the first message is a LOAD INFORMATION message, wherein the LOAD INFORMATION message comprises a TDD subframe assignment invoke included in an Invoke Indication IE, and the TDD subframe assignment invoke is used for indicating the invoke of the response of the current TDD subframe configuration of the second base station.

14. The apparatus of claim 12, wherein the second message is an ENB CONFIGURATION UPDATE message.
